(19) United States
(12) Patent Application Publication
(10) Pub. No.: US 2026/0086469 A1
(43) Pub. Date: Mar. 26, 2026

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Daisuke ISHIZUKA, Kanagawa (JP); Narumasa SATO, Kanagawa (JP); Eiji KAWAKAMI, Kanagawa (JP); Mako TSUCHIYA, Kanagawa (JP); Tsutomu FURUTA, Kanagawa (JP)

(73) Assignee: FUJIFILM Business Innovation Corp., Tokyo (JP)

(21) Appl. No.: 19/220,132

(22) Filed: May 28, 2025

(30) Foreign Application Priority Data
Sep. 24, 2024 (JP) 2024-165676
Mar. 26, 2025 (JP) 2025-052633

(51) Int. Cl. G03G 9/087

(52) U.S. Cl. CPC G03G 9/08755; G03G 9/08711; G03G 9/08782

(57) ABSTRACT

An electrostatic charge image developing toner contains toner particles containing a binder resin, a release agent, and resin particles forming a domain inside the toner particles, in which the binder resin includes a polyester resin, an average ester group concentration c1 of the binder resin is 25% by mass or more and 48% by mass or less, and in a case where an ester group concentration of the resin particles is denoted by c2, a value of c2/c1 is 0.30 or more and 0.70 or less.

### CROSS-REFERENCE TO RELATED APPLICATIONS

This application is based on and claims priority under 35 USC 119 from Japanese Patent Application No. 2025-052633 filed Mar. 26, 2025 and Japanese Patent Application No. 2024-165676 filed Sep. 24, 2024.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2019-74761A discloses a manufacturing method of a toner (Z) containing a colorant, a crystalline resin (A), and a vinyl-based resin (B) having an ester group, in which the vinyl-based resin (B) includes a resin (LB) having at least one peak in a region of a molecular weight of 3,000 to 60,000 in a molecular weight distribution obtained by gel permeation chromatography, an ester group concentration of the vinyl-based resin (B) is 14% to 55% by weight based on a weight of the (B), a content of the vinyl-based resin (B) is 50% to 90% by weight based on a weight of the toner (Z), and the method includes a step of aggregating a dispersion (X) in a dispersion liquid (W) containing the colorant, the crystalline resin (A), and the vinyl-based resin (B) to obtain an aggregate (Y), and heating the aggregate (Y) to fuse the aggregate (Y) to obtain resin particles (Z′).

JP2018-163200A discloses an electrostatic charge image developing toner containing toner particles that contain a polyester resin consisting of a polyvalent carboxylic acid and a polyhydric alcohol, in which the polyhydric alcohol includes ethylene glycol, and a mass ratio of the ethylene glycol to all polyhydric alcohols is 40% by mass or more and 90% by mass or less, and an external additive that contains silica particles in which a product of a volume-average particle size D50 (μm) and a BET specific surface area SA (m²/g) is 1.4×10³ or more and 5.0×10³ or less.

JP2017-142409A discloses an electrostatic latent image developing toner containing a plurality of toner particles that have a sea-like domain substantially formed of a plurality of resins including at least a polyester resin containing an alcohol component having 2 or more and 6 or less carbon atoms and a plurality of island-like domains distributed in an island-like manner with respect to the sea-like domain, in which the island-like domain is substantially formed of a resin containing a nigrosin dye, a dispersion size of the island-like domain is 0.1 μm or more and 1.0 μm or less, the sea-like domain contains the polyester resin containing an alcohol component having 2 or more and 6 or less carbon atoms at a proportion of 5% by mass or more and 50% by mass or less with respect to the total amount of the plurality of resins, and a ratio of an SP value of the resin constituting the sea-like domain to an SP value of the resin constituting the island-like domain is 0.98 or less or 1.20 or more.

JP2008-15023A discloses an electrostatic latent image developing toner containing a binder resin, a colorant, and a release agent, in which the toner contains less than 3% by weight of a styrene copolymer having a weight-average molecular weight (Mw) in a range of 70,000 to 300,000 and an acid value (AV) in a range of 70 mgKOH/g to 220 mgKOH/g.

### SUMMARY

Aspects of non-limiting embodiments of the present disclosure relate to an electrostatic charge image developing toner containing toner particles that contain a binder resin including a polyester resin, a release agent, and resin particles forming a domain inside the toner particles, in which density unevenness suppression property is excellent in a high humidity environment (25° C., 80% RH), as compared with a case where an average ester group concentration c1 of the binder resin is less than 25% by mass or more than 48% by mass or a case where, as an ester group concentration of the resin particles is denoted by c2, a value of c2/c1 is less than 0.30 or more than 0.70.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided an electrostatic charge image developing toner including toner particles that contain a binder resin, a release agent, and resin particles forming a domain inside the toner particles, in which the binder resin includes a polyester resin, an average ester group concentration c1 of the binder resin is 25% by mass or more and 48% by mass or less, and in a case where an ester group concentration of the resin particles is denoted by c2, a value of c2/c1 is 0.30 or more and 0.70 or less.

### BRIEF DESCRIPTION OF THE DRAWINGS

Exemplary embodiment(s) of the present invention will be described in detail based on the following figures, wherein:

FIG. 1 is a view schematically showing a configuration of an image forming apparatus according to the present exemplary embodiment; and

FIG. 2 is a view schematically showing a configuration of a process cartridge according to the present exemplary embodiment.

### DETAILED DESCRIPTION

Exemplary embodiments of the present invention will be described below. The following descriptions and examples merely illustrate the exemplary embodiments, and do not limit the scope of the exemplary embodiments.

In the present exemplary embodiments, a numerical range described using “to” represents a range including numerical values listed before and after “to” as the minimum value and the maximum value respectively.

Regarding the numerical ranges described in stages in the present exemplary embodiment, the upper limit value or lower limit value of a numerical range may be replaced with the upper limit value or lower limit value of another numerical range described in stages. In addition, in the present exemplary embodiment, the upper limit value or lower limit value of a numerical range may be replaced with values described in examples.

In the present exemplary embodiment, the term “step” includes not only an independent step but a step that is not clearly distinguished from other steps as long as the intended purpose of the step is achieved.

In the present exemplary embodiments, each component may include a plurality of corresponding substances. In the present exemplary embodiment, in a case where the amount of each component in a composition is mentioned, and there are two or more kinds of substances corresponding to each component in the composition, unless otherwise specified, the amount of each component means the total amount of two or more kinds of the substances present in the composition.

In the present exemplary embodiments, each component may include a plurality of corresponding particles. In a case where there are two or more kinds of particles corresponding to each component in a composition, unless otherwise specified, the particle size of each component means a value for a mixture of two or more kinds of the particles present in the composition.

In the present exemplary embodiment, “(meth)acrylic” is an expression including both acrylic and methacrylic, and “(meth)acrylate” is an expression including both acrylate and methacrylate.

In the present exemplary embodiment, “electrostatic charge image developing toner” is also referred to as “toner”.

### Electrostatic Charge Image Developing Toner

The electrostatic charge image developing toner according to the present exemplary embodiment contains toner particles that contain a binder resin, a release agent, and resin particles forming a domain inside the toner particles, in which the binder resin includes a polyester resin, an average ester group concentration c1 of the binder resin is 25% by mass or more and 48% by mass or less, and in a case where an ester group concentration of the resin particles is denoted by c2, a value of c2/c1 is 0.30 or more and 0.70 or less.

In printing in a high humidity environment, the toner in the related art may cause fixing failure and the like because of heat being taken away by moisture in the paper due to moisture absorption of the paper. In contrast, it is possible to improve fixing property by controlling hygroscopicity of the binder resin; but on the other hand, since the binder resin is easily softened, bleeding of the binder resin to the surface of particles of a release agent is excessive, and density unevenness of the image due to an offset of the release agent may occur.

In the electrostatic charge image developing toner according to the present exemplary embodiment, the average ester group concentration c1 of the binder resin is 25% by mass or more and 48% by mass or less, and in a case where the ester group concentration of the resin particles is denoted by c2, the value of c2/c1 is 0.30 or more and 0.70 or less, and thus it is presumed as follows. First, it is possible to ensure fixing performance to the paper that is appropriately plasticized and absorbed in a high humidity environment. Furthermore, in a case where the binder resin starts to melt, the resin particles are likely to aggregate, and in this case, the resin particles aggregate in a form of being entangled with wax in the aggregate, and thus the growth of the release agent can be suppressed. As a result, the amount of bleeding of the release agent is stable regardless of the humidity, and the occurrence of the density unevenness of the image may be suppressed even in a high humidity environment.

Hereinafter, the configuration of the electrostatic charge image developing toner according to the present exemplary embodiment will be described in detail.

### Toner Particles

The toner particles contain a binder resin and resin particles, and optionally contain a colorant, a release agent, and other additives.

### Ester Group Concentration

In the electrostatic charge image developing toner according to the present exemplary embodiment, the average ester group concentration c1 of the above-described binder resin is 25% by mass or more and 48% by mass or less, and in a case where the ester group concentration of the above-described resin particles is denoted by c2, the value of c2/c1 is 0.30 or more and 0.70 or less.

From the viewpoint of density unevenness suppression property in a high humidity environment, the average ester group concentration c1 of the above-described binder resin is, for example, preferably 28% by mass or more and 47% by mass or less, more preferably 30% by mass or more and 45% by mass or less, and particularly preferably 35% by mass or more and 43% by mass or less.

From the viewpoint of density unevenness suppression property in a high humidity environment, the above-described value of c2/c1 is, for example, preferably 0.32 or more and 0.68 or less, more preferably 0.35 or more and 0.65 or less, and particularly preferably 0.40 or more and 0.60 or less.

From the viewpoint of density unevenness suppression property in a high humidity environment, the ester group concentration c2 of the above-described resin particles is, for example, preferably 7% by mass or more and 30% by mass or less, more preferably 10% by mass or more and 25% by mass or less, and particularly preferably 12% by mass or more and 21% by mass or less.

From the viewpoint of further exhibiting the effect of the present exemplary embodiment, an ester group concentration c3 of the above-described release agent is, for example, preferably 15% by mass or less, more preferably 10% by mass or less, still more preferably 7% by mass or less, and particularly preferably 0% by mass.

The ester group concentration can be calculated from the number of ester groups [—C(═O)O—] in the resin or the compound, and specifically, is represented by the following expression.

$$Ester group concentration ( \% by mass ) = [ ( N \times 44 ) / number - average molecular weight ] \times 100$$

Here, N is the average number of ester groups per molecule, and 44 is a formula weight of the ester group [—C(═O)O—].

The chemical structure of the resin or the compound is calculated by obtaining a monomer formulation or chemical structure and the number of ester groups by using a nuclear magnetic resonance (NMR) spectrum or the like.

### Resin Particles

The above-described toner particles contain resin particles forming a domain inside the toner particles.

Examples of the resin particles include internally-added resin particles of a polyolefin-based resin (such as polyethylene and polypropylene), a styrene-based resin (such as polystyrene and poly(α-methylstyrene), a (meth)acrylic resin (such as polymethyl methacrylate and polyacrylonitrile), an epoxy resin, a polyurethane resin, a polyurea resin, a polyamide resin, a polycarbonate resin, a polyether resin, a polyester resin, copolymer resins of these compounds, and the like.

From the viewpoint of density unevenness suppression property in a high humidity environment, for example, styrene-(meth)acrylic resin particles are preferable as the resin particles.

### Average Equivalent Circle Diameter of Domain Formed by Resin Particles

From the viewpoint of density unevenness suppression property in a high humidity environment, an average equivalent circle diameter of the domains formed by the above-described resin particles is, for example, preferably 50 nm or more and 300 nm or less, more preferably 100 nm or more and 250 nm or less, and particularly preferably 120 nm or more and 190 nm or less.

The average equivalent circle diameter of the domains formed by the resin particles is a value measured using a transmission electron microscope (TEM).

As the transmission electron microscope, for example, JEM-2100plus manufactured by JEOL Ltd. can be used.

Specifically, the average equivalent circle diameter of the domain formed by the resin particles is measured as follows.

The toner particles are mixed with and embedded in an epoxy resin, and the epoxy resin is solidified. The obtained solidified product is cut with a microtome to have a thickness of approximately 0.1 μm. The obtained thin sample is dyed with ruthenium tetroxide in a desiccator at 30° C. A cross section of the dyed thin sample is imaged at 10,000× magnification by using the transmission electron microscope, equivalent circle diameters of 100 internally-added resin particles dispersed in the toner particles are calculated based on the cross-sectional areas of the particles, and an arithmetic average thereof is calculated and adopted as the average equivalent circle diameter.

### Tetrahydrofuran-Insoluble Amount

From the viewpoint of density unevenness suppression property in a high humidity environment, a tetrahydrofuran-insoluble amount of the above-described resin particles is, for example, preferably 80% by mass or more, more preferably 85% by mass or more, and particularly preferably 90% by mass or more.

A method of measuring the THF-insoluble amount in the present exemplary embodiment will be described.

(1) 0.25 g of the sample is weighed, 40 mL of tetrahydrofuran is added thereto, and the mixture is mixed and stirred for 3 hours.

(2) Thereafter, the mixed solution obtained in (1) is separated by a centrifuge at 2,000 revolutions per minute (rpm) for 30 minutes.

(3) 5 mL of the supernatant liquid after the centrifugation obtained in (2) is weighed, and transferred to an aluminum dish, and tetrahydrofuran is evaporated and dried in a vacuum dryer adjusted to a temperature of 50° C.

(4) From a difference in mass of the aluminum dish before and after the drying, the THF-insoluble fraction is calculated according to the following expression.

$$THF - insoluble fraction [ \% ] = \{ 0.25 - [ ( Mass of supernatant liquid and aluminum dish ) - ( Mass of aluminum dish after drying ) ] \times 8 \} / 0.25 \times 100$$

### Monomer Configuration of Styrene-(Meth)Acrylic Resin Particles

Examples of the styrene-(meth)acrylic resin particles in the present exemplary embodiment include resin particles obtained by polymerizing a (meth)acrylic monomer such as the following styrene-based monomer and (meth)acrylate-based monomer by radical polymerization.

Examples of the styrene-based monomer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the styrene-based monomers, for example, styrene or α-methylstyrene is preferable.

Examples of the (meth)acrylate monomer include methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide.

As the (meth)acrylate-based monomer, from the viewpoint of ease of adjusting an ester group concentration of the styrene-(meth)acrylic resin, for example, a (meth)acrylate compound having an alkyl group having 2 to 12 carbon atoms (also referred to as “number of carbon atoms”) is preferable, a (meth)acrylate compound having an alkyl group having 2 to 10 carbon atoms is more preferable, and a (meth)acrylate compound having an alkyl group having 4 to 8 carbon atoms is particularly preferable.

Among the above, as the (meth)acrylate-based monomer, for example, n-butyl (meth)acrylate of a styrene-(meth)acrylic resin is particularly preferable.

In addition, from the viewpoint of density unevenness suppression property in a high humidity environment, the resin particles are, for example, preferably crosslinked resin particles.

Examples of a crosslinking agent for forming a crosslinked structure include aromatic polyfunctional vinyl compounds such as divinylbenzene and divinylnaphthalene; polyvalent vinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic carboxylic acid compounds, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy,1,3-diacryloxypropane; and polyfunctional vinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of crosslinking agent may be used alone, or two or more kinds of crosslinking agents may be used in combination.

Among the above, as the crosslinking agent, for example, it is preferable to use an alkylene glycol diacrylate having an alkylene chain having 6 or more carbon atoms. That is, for example, the resin particles preferably have a constitutional unit derived from an alkylene glycol diacrylate, and the number of carbon atoms in the alkylene chain of the alkylene glycol diacrylate is preferably 6 or more.

From the viewpoint of adjusting the crosslinking density to an appropriate range, the number of carbon atoms in the alkylene chain of the alkylene glycol diacrylate is, for example, preferably 6 or more, more preferably 6 or more and 12 or less, and still more preferably 8 or more and 12 or less. More specific examples of the alkylene glycol diacrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and among these, for example, 1,10-decanediol diacrylate or 1,10-decanediol dimethacrylate is preferable.

A content of the crosslinking agent in a composition for forming the resin particles with respect to 100 parts by mass of the total amount of the monomers used is, for example, preferably 0.1 parts by mass or more and 5.0 parts by mass or less, more preferably 0.2 parts by mass or more and 3.0 parts by mass or less, and still more preferably 0.3 parts by mass or more and 2.5 parts by mass or less.

From the viewpoint of density unevenness suppression property in a high humidity environment, a content of the resin particles with respect to the total amount of the toner particles is, for example, preferably 1% by mass or more and 30% by mass or less, more preferably 3% by mass or more and 25% by mass or less, and still more preferably 4% by mass or more and 16% by mass or less.

### Release Agent

The toner particles contain a release agent.

Examples of the release agent include hydrocarbon-based wax; natural wax such as carnauba wax, rice wax, and candelilla wax; synthetic or mineral·petroleum-based wax such as montan wax; and ester-based wax such as fatty acid esters and montanic acid esters. The release agent is not limited to the agents.

Among the above, from the viewpoint of further exhibiting the effect of the present exemplary embodiment, for example, it is preferable to include at least one selected from the group consisting of a hydrocarbon wax and an ester wax.

From the viewpoint of density unevenness suppression property in a high humidity environment, a melting point of the release agent is, for example, preferably 60° C. or higher and 120° C. or lower, more preferably 63° C. or higher and 110° C. or lower, and particularly preferably 75° C. or higher and 100° C. or lower.

The melting point is determined from a DSC curve obtained by differential scanning calorimetry (DSC) by “peak melting temperature” described in the method for determining the melting temperature in JIS K 7121-1987, “Testing methods for transition temperatures of plastics”.

From the viewpoint of density unevenness suppression property in a high humidity environment, a content of the release agent is, for example, preferably 1% by mass or more and 10% by mass or less, more preferably 2% by mass or more and 9% by mass or less, and particularly preferably 3% by mass or more and 8% by mass or less with respect to the total mass of the above-described toner particles.

In addition, in a case where the content of the release agent in the toner particles is denoted by Ww and the content of the resin particles in the toner particles is denoted by Wb, from the viewpoint of density unevenness suppression property in a high humidity environment, a value of Wb/Ww is, for example, preferably 0.3 or more and 5.0 or less, more preferably 0.5 or more and 4.0 or less, and particularly preferably more than 1.0 and 3.0 or less.

Furthermore, from the viewpoint of density unevenness suppression property in a high humidity environment, for example, it is preferable that the content Wb of the resin particles in the toner particles is larger than the content Ww of the release agent.

### Binder Resin

The toner particles contain an amorphous polyester resin as the binder resin.

In addition, the toner particles may contain a binder resin other than the amorphous polyester resin.

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable.

Examples of the polyester resin include known amorphous polyester resins. As the polyester resin, a crystalline polyester resin may be used in combination with an amorphous polyester resin.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (C/min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid (hexenyl succinic acid, octenyl succinic acid, dodecenyl succinic acid, pentadecenyl succinic acid, and the like), adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 70° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HLC-8320GPC manufactured by Tosoh Corporation as a measurement device, TSKgel Super HM-M (15 cm) manufactured by Tosoh Corporation as a column, and tetrahydrofuran (THF) as a solvent. The weight-average molecular weight and the number-average molecular weight are calculated using a molecular weight calibration curve plotted using a monodisperse polystyrene standard sample from the measurement results.

One kind of amorphous polyester resin may be used alone, or two or more kinds of amorphous polyester resins may be used in combination. In a case where two or more kinds thereof are used in combination, for example, a high-molecular-weight form and a low-molecular-weight form may be used in combination.

The amorphous polyester resin is obtained by a known manufacturing method. Specifically, for example, the amorphous polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 2 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among the aliphatic diols, for example, 1,6-hexanediol, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 50,000 or less.

The crystalline polyester resin can be obtained by a known manufacturing method, for example, same as the amorphous polyester resin.

A hybrid resin having a polyester resin segment and a styrene-acrylic copolymer segment may be adopted as the polyester resin.

A content of the binder resin with respect to the total amount of the toner particles is, for example, preferably 40% by mass or more and 95% by mass or less, more preferably 50% by mass or more and 92% by mass or less, and still more preferably 55% by mass or more and 90% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; inorganic pigments such as a titanium compound, silica, aluminum, and mica; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

The colorant is not limited to a substance having absorption in the visible light region. The colorant may be, for example, a substance having absorption in a near infrared region, a fluorescent colorant, or a colorant having lustrousness.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Other Additives

Examples of other additives include known additives such as a magnetic material, a charge control agent, and inorganic powder. The additives are incorporated into the toner particles as internal additives.

### Characteristics and the Like of Toner Particles

The toner particles may be toner particles that have a single-layer structure or toner particles having a so-called core/shell structure that is configured with a core portion (core particle) and a coating layer (shell layer) coating the core portion.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER 3 (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER 3 with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume particle size D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The average circularity of the toner particles is, for example, preferably 0.90 or more and 1.00 or less, and more preferably 0.92 or more and 0.98 or less.

The average circularity of the toner particles is determined by (Equivalent circular perimeter)/(Perimeter) [(Perimeter of circle having the same projected area as particle image)/(Perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (Parshe Analyzer PAS, manufactured by HOSOKAWA MICRON CORPORATION) performing image analysis on the particle image, the average circularity is determined. The number of samplings for determining the average circularity is 10,000.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning lubricant (for example, and a metal salt of a higher fatty acid represented by zinc stearate or particles of higher alcohols).

The amount of the external additive externally added with respect to the toner particles is, for example, preferably 0.01% by mass or more and 10% by mass or less, and more preferably 0.01% by mass or more and 6.0% by mass or less.

### Manufacturing Method of Electrostatic Charge Image Developing Toner

The electrostatic charge image developing toner according to the present exemplary embodiment is obtained by producing toner particles and then adding the external additive to the exterior of the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

Specifically, for example, in a case where the toner particles are manufactured by the aggregation and coalescence method, for example, the toner particles are manufactured through a step (first aggregated particle-forming step) of forming first aggregated particles by mixing an initial resin particle dispersion in which initial resin particles forming a domain are dispersed, a first resin particle dispersion in which first resin particles as a binder resin are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second resin particles as a binder resin to the first aggregated particle dispersion, and aggregating the second resin particles on a surface of the first aggregated particles; and a step (coalescence step) of heating the second aggregated particle dispersion in which the second aggregated particles are dispersed to allow the second aggregated particles to undergo coalescence and to form toner particles.

The present aggregation and coalescence method will be described as a method for producing toner particles containing a binder resin, a colorant, and a release agent; but the colorant and the release agent are components to be contained in the toner particles as necessary.

Hereinafter, each of the steps will be specifically described.

### Each Dispersion Preparing Step

First, each dispersion to be used in the aggregation and coalescence method is prepared. Specifically, the initial resin particle dispersion in which the initial resin particles forming a domain are dispersed, the first resin particle dispersion in which the first resin particles as the binder resin are dispersed, the colorant dispersion in which the colorants are dispersed, the second resin particle dispersion in which the second resin particles as the binder resin are dispersed, and the release agent particle dispersion in which the release agent particles are dispersed are prepared.

In each dispersion preparing step, the initial resin particles, the first resin particles, and the second resin particles will be referred to and described as “resin particles”.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-960 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant dispersion and a release agent particle dispersion are prepared in the same manner as that adopted for preparing the resin particle dispersion. That is, the volume-average particle size of the particles, the dispersion medium, the dispersion method, and the content of the particles in the resin particle dispersion are also applied to the colorant to be dispersed in the colorant dispersion and the release agent particles to be dispersed in the release agent particle dispersion.

### First Aggregated Particle-Forming Step

Next, the initial resin particle dispersion and the first resin particle dispersion are mixed with the colorant dispersion and the release agent particle dispersion.

In the mixed dispersion, the initial resin particles, the first resin particles, the colorant, and the release agent particles are hetero-aggregated to form the first aggregated particles including the initial resin particles, the first resin particles, the colorant, and the release agent particles.

Specifically, for example, an aggregating agent is added to a dispersion obtained by mixing the initial resin particle dispersion, the first resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of the first resin particles is, for example, preferably 0.01 parts by mass or more and 5.0 parts by mass or less, and more preferably 0.1 parts by mass or more and less than 3.0 parts by mass.

In addition, in order to adjust the effect of the chelating agent, an alkali may be added to adjust the pH in the system.

### Second Aggregated Particle-Forming Step

Next, after obtaining the first aggregated particle dispersion in which the first aggregated particles are dispersed, a second resin particle dispersion in which second resin particles are dispersed is added to the first aggregated particle dispersion.

The second resin particles may be of the same type as the first resin particles, or may be of different types.

Next, the second resin particles are aggregated on the surface of the first aggregated particles in the dispersion of the first aggregated particles and the second resin particles. In this case, by adding the release agent particle dispersion, the second resin particles and the release agent particles may be aggregated on the surface of the first aggregated particles. Specifically, for example, in the first aggregated particle-forming step, in a case where the first aggregated particles reach a target particle size, the second resin particle dispersion is added to the first aggregated particle dispersion, and the mixture is heated at a temperature equal to or lower than the glass transition temperature of the second resin particles.

By setting the pH of the dispersion in a range of, for example, about 6.5 or more and 8.5 or less, the progress of aggregation is stopped.

In this way, the second aggregated particles are obtained in which the second resin particles are aggregated to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second amorphous resin particles (for example, a temperature higher than the glass transition temperatures of the first and second resin particles by 10° C. to 30° C.) such that the second aggregated particles coalesce, thereby forming toner particles.

In addition, in order to control the shape, the pH in the system may be adjusted by adding an acid as necessary.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

Here, after the coalescence step ends, the toner particles in the dispersion are subjected to a known washing step, a solid-liquid separation step, and a drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lödige mixer, or the like. In addition, the external additive may be mixed with the toner particles at once, or the external additive may be added to the toner particles stepwise and mixed a plurality of times. Furthermore, coarse particles of the toner may be removed as necessary by using a vibratory sieving machine, a pneumatic sieving machine, or the like.

### Electrostatic Charge Image Developer

The electrostatic charge image developer according to the present exemplary embodiment contains at least the electrostatic charge image developing toner according to the present exemplary embodiment.

The electrostatic charge image developer according to the present exemplary embodiment may be a one-component developer that contains only the electrostatic charge image developing toner according to the present exemplary embodiment or a two-component developer that is obtained by mixing the electrostatic charge image developing toner and a carrier together.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating the surface of a core material, that is particles configuring the carrier, with a resin.

Examples of the magnetic powder include magnetic metals such as iron, nickel, and cobalt; and magnetic oxides such as ferrite and magnetite.

In particular, as a magnetic powder, for example, magnetite or ferrite is preferable. The magnetic powder may be used as particles in which the magnetic powder is dispersed in a resin.

Examples of the coating resin and the matrix resin include a styrene. (meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride·vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea·formaldehyde resin; and an epoxy resin.

For example, the coating resin and the matrix resin preferably contain a (meth)acrylic resin, and preferably contain a (meth)acrylic resin having an alicyclic structure. The coating resin and the matrix resin may contain a nitrogen-containing (meth)acrylic resin.

A content of the (meth)acrylic resin is, for example, more preferably 50% by mass or more, and still more preferably 80% by mass or more with respect to the total mass of the coating resin and the matrix resin.

In particular, for example, the coating resin and the matrix resin preferably contain an alicyclic (meth)acrylic resin as the (meth)acrylic resin.

The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

Examples of the other additives include particles overlapping with the above-described conductive particles, but also include metal oxide particles such as silica, titanium oxide, zinc oxide, and tin oxide; metal compound particles such as barium sulfate, aluminum borate, and potassium titanate; and metal particles such as gold, silver, and copper. Among the above, for example, silica particles are preferable.

A content of the above-described particles is, for example, preferably 10% by mass or more and 60% by mass or less with respect to the total mass of the resin layer.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; and an apparatus including a cleaning device that cleans the surface of the image holder before charging after the transfer of the toner image or an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with a surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to be detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

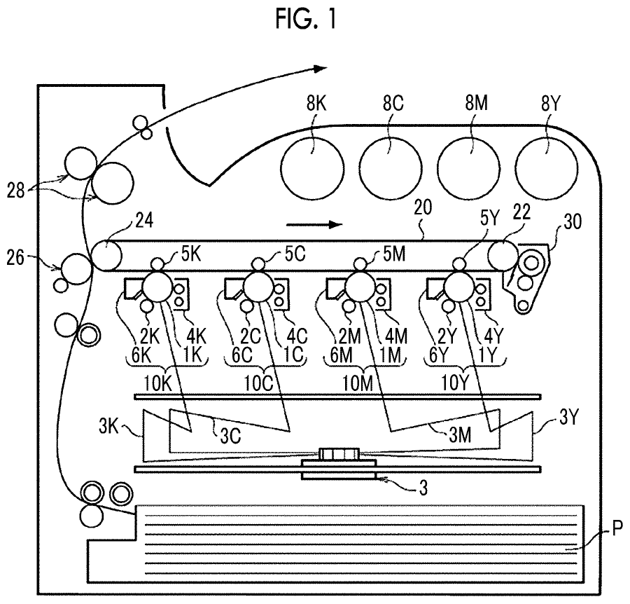

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that is in contact with the inner surface of the intermediate transfer belt 20, the rolls 22 and 24 being disposed to be spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described, which is placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.:1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. The image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface side of the intermediate transfer belt 20. On the other hand, via a supply mechanism, recording paper P (an example of recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in a fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

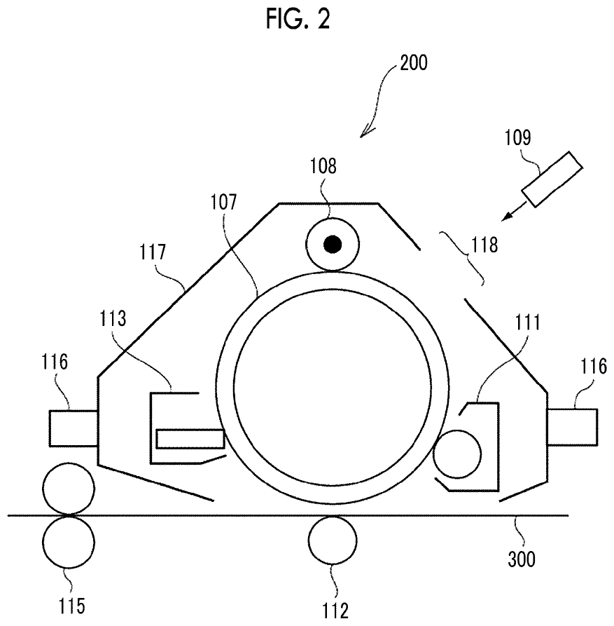

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing device provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Hereinafter, exemplary embodiments of the present invention will be specifically described based on Examples. However, the exemplary embodiments of the present invention are not limited to Examples.

In the following description, unless otherwise specified, “parts” and “%” are based on mass.

Unless otherwise specified, the synthesis, treatment, manufacturing, and the like are carried out at room temperature (25° C.±3° C.).

### Example 1

### Production of Toner Particles (1)

### Preparation of Amorphous Polyester Resin Dispersion (1) (PES1)

Terephthalic acid: 100 parts by mole
Ethylene glycol: 60 parts by mole
Propylene glycol: 30 parts by mole
Propylene oxide (2 mol) adduct of bisphenol A: 10 parts by mole

The above-described materials are charged into a reaction vessel equipped with a stirrer, a nitrogen introduction tube, a temperature sensor, and a rectifying column, the temperature is raised to 190° C. over 1 hour, and dibutyltin oxide is added to the mixture in an amount of 1.2 parts with respect to 100 parts of the above-described materials. While the generated water is distilled off, the temperature is raised to 240° C. for 6 hours, a dehydration condensation reaction is continued for 3 hours in the reaction solution retained at 240° C., and then the reactant is cooled to obtain an amorphous polyester resin (1).

An ester group concentration of the obtained amorphous polyester resin (1) is 38.9% by mass.
Amorphous polyester resin (1): 100 parts
Methyl ethyl ketone: 60 parts
Isopropanol: 15 parts
10% Aqueous ammonia solution: 3.6 parts

The above-described materials are put in a jacketed reaction tank equipped with a condenser, a thermometer, a water dripping device, and an anchor blade, and in a state in which the reaction tank is retained at a liquid temperature of 50° C. in a water-circulation type thermostatic bath, the amorphous polyester resin (1) is dissolved while stirring and mixing the mixture at 100 rpm. Next, the water-circulation type thermostatic bath is set to 40° C., and a total of 300 parts of deionized water retained at 40° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the obtained dispersion, thereby obtaining an amorphous polyester resin dispersion (1) having a solid content of 20% by mass.

### Preparation of Styrene-(Meth)Acrylate Copolymer Particle Dispersion (1) (B1)

### Preparation of Emulsion (1)

### Emulsion (1)

Styrene: 40 parts
n-Butyl acrylate: 58.5 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (1).

0.4 parts of an anionic surfactant (ELEMINOL MON-2) and 100 parts of deionized water are charged into a reaction vessel equipped with a stirrer and a nitrogen introduction tube, after replacing the inside of the reaction vessel with nitrogen. The reaction solution is heated in an oil bath while being stirred so that a temperature of the reaction solution is set to 70° C. After adding 5 parts of the emulsion (1) thereto, 10 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 70° C., 195 parts of the emulsion (1) is gradually added dropwise to the reaction vessel over 60 minutes by a pump.

After completion of the dropwise addition, the solution is retained for 60 minutes, 1 part of ammonium persulfate having a concentration of 10% by mass is added thereto, and the mixture is retained for another 3 hours and then cooled to room temperature. Thereafter, deionized water and nitric acid are added thereto so that the concentration of solid content is 20% by mass, thereby preparing a styrene-(meth)acrylate copolymer particle dispersion (1).

An ester group concentration of the obtained resin particles is 17.0% by mass.

### Preparation of Release Agent Particle Dispersion (1)

Paraffin wax w1 (HNP9, manufactured by NIPPON SEIRO CO., LTD.): 100 parts
Anionic surfactant (NEOPELEX G-65, manufactured by Kao Corporation): 5 parts
Deionized water: 300 parts

The above-described materials are mixed together, heated to 100° C., and dispersed using a homogenizer (ULTRA-TURRAX T50). Furthermore, a dispersion treatment is performed using a Manton-Gaulin high-pressure homogenizer (manufactured by Gaulin Corporation), and deionized water is added to the dispersion, thereby obtaining a release agent particle dispersion (1) having a solid content of 20% by mass.

An ester group concentration of the release agent particles in the release agent particle dispersion (1) is 0% by mass.

### Preparation of Colorant Dispersion

Carbon black (Regel 330, manufactured by Cabot Corporation): 110 parts
Anionic surfactant (NEOPELEX G-65, manufactured by Kao Corporation): 6 parts
Deionized water: 300 parts

The above-described materials are mixed together and dispersed for 10 minutes using a homogenizer (ULTRA-TURRAX T50, manufactured by IKA). Deionized water is added to the dispersion, thereby obtaining a colorant dispersion having a solid content of 20% by mass. A volume-average particle size of the colorant particles in the colorant dispersion is 220 nm.

### Production of Toner (1)

Amorphous polyester resin dispersion (1) (solid content: 20% by mass): 51 parts
Styrene-(meth)acrylate copolymer particle dispersion (1) (solid content: 20% by mass): 8 parts
Colorant dispersion (solid content: 20% by mass): 8 parts
Release agent particle dispersion (1) (solid content: 20% by mass): 7 parts
Anionic surfactant (ELEMINOL MON-2): 0.7 parts
Deionized water: 50 parts

The above-described materials are put in a reaction vessel equipped with a thermometer, a pH meter, and a stirrer, and the temperature of the reaction vessel is kept at 20° C. and retained for 30 minutes while stirring at a rotation speed of 150 rpm. Next, a 0.3N nitric acid aqueous solution is added thereto such that the pH is adjusted to 5.0, and then a 2% aluminum sulfate aqueous solution is added thereto in a state in which the reaction solution is dispersed with a homogenizer (ULTRA-TURRAX T50). Next, in a state in which the reaction solution is stirred, the temperature thereof is raised to 45° C. at a rate of 0.4° C./min and retained for 30 minutes.

Next, 26 parts of the amorphous polyester resin dispersion (1) is added thereto, and the mixture is retained for 30 minutes. Next, a 1.0 N(=1.0 mol/L) sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours. Next, after cooling, solid-liquid separation, and washing of solid matter with deionized water, the solid matter is dried for 24 hours in a freeze vacuum dryer to obtain toner particles (1) having a volume-average particle size of 5.4 μm.
100 parts of the toner particles (1) and 2.0 parts of hydrophobic silica (manufactured by Nippon Aerosil Co., Ltd.; product name: RY200) are mixed with a Henshell mixer to obtain a toner 1.
c2/c1 of the toner (1) is 0.44.

### Examples 2 to 27 and Comparative Examples 1 and 2

Each toner is produced in the same manner as in Example 1, except that the types and addition amounts of the amorphous polyester resin, the resin particles, and the release agent are changed as shown in Table 1.

The preparation method of each amorphous polyester resin, the preparation method of the resin particles, and the type of the release agent are shown below.

### Preparation of Amorphous Polyester Resin Dispersion (2) (PES2)

An amorphous polyester resin (2) is obtained in the same manner as in the preparation of the amorphous polyester resin (1), except that charging of the materials is changed as follows.
Terephthalic acid: 70 parts by mole
Fumaric acid: 30 parts by mole
Ethylene glycol: 65 parts by mole
Propylene glycol: 35 parts by mole

An ester group concentration of the obtained amorphous polyester resin (2) is 48.0% by mass.

An amorphous polyester resin dispersion (2) having a solid content of 20% by mass is obtained in the same manner as in the preparation of the amorphous polyester resin dispersion (1), except that the amorphous polyester resin (1) is changed to the amorphous polyester resin (2).

### Preparation of Amorphous Polyester Resin Dispersion (3) (PES3)

An amorphous polyester resin (3) is obtained in the same manner as in the preparation of the amorphous polyester resin (1), except that charging of the materials is changed as follows.
Terephthalic acid: 80 parts by mole
Isophthalic acid: 10 parts by mole
Fumaric acid: 10 parts by mole
Ethylene glycol: 50 parts by mole
Propylene glycol: 50 parts by mole

An ester group concentration of the obtained amorphous polyester resin (3) is 45.0% by mass.

An amorphous polyester resin dispersion (3) having a solid content of 20% by mass is obtained in the same manner as in the preparation of the amorphous polyester resin dispersion (1), except that the amorphous polyester resin (1) is changed to the amorphous polyester resin (3).

### Preparation of Amorphous Polyester Resin Dispersion (4) (PES4)

An amorphous polyester resin (4) is obtained in the same manner as in the preparation of the amorphous polyester resin (1), except that charging of the materials is changed as follows.
Terephthalic acid: 100 parts by mole
Ethylene glycol: 60 parts by mole
Propylene glycol: 5 parts by mole
Propylene oxide (2 mol) adduct of bisphenol A: 35 parts by mole

An ester group concentration of the obtained amorphous polyester resin (4) is 30.0% by mass.

An amorphous polyester resin dispersion (4) having a solid content of 20% by mass is obtained in the same manner as in the preparation of the amorphous polyester resin dispersion (1), except that the amorphous polyester resin (1) is changed to the amorphous polyester resin (4).

### Preparation of Amorphous Polyester Resin Dispersion (5) (PES5)

An amorphous polyester resin (5) is obtained in the same manner as in the preparation of the amorphous polyester resin (1), except that charging of the materials is changed as follows.
Terephthalic acid: 100 parts by mole
Ethylene glycol: 5 parts by mole
Propylene glycol: 5 parts by mole
Neopentyl glycol: 40 parts by mole
Propylene oxide (2 mol) adduct of bisphenol A: 50 parts by mole

An ester group concentration of the obtained amorphous polyester resin (5) is 25.0% by mass.

An amorphous polyester resin dispersion (5) having a solid content of 20% by mass is obtained in the same manner as in the preparation of the amorphous polyester resin dispersion (1), except that the amorphous polyester resin (1) is changed to the amorphous polyester resin

(5).

### Preparation of Amorphous Polyester Resin Dispersion (6) (PES6)

An amorphous polyester resin (6) is obtained in the same manner as in the preparation of the amorphous polyester resin (1), except that charging of the materials is changed as follows.
Terephthalic acid: 70 parts by mole
Adipic acid: 25 parts by mole
Fumaric acid: 5 parts by mole
Ethylene glycol: 35 parts by mole
Propylene glycol: 30 parts by mole
Propylene oxide (2 mol) adduct of bisphenol A: 15 parts by mole
Ethylene oxide (2 mol) adduct of bisphenol A: 20 parts by mole

An ester group concentration of the obtained amorphous polyester resin (6) is 31.0% by mass.

An amorphous polyester resin dispersion (6) having a solid content of 20% by mass is obtained in the same manner as in the preparation of the amorphous polyester resin dispersion (1), except that the amorphous polyester resin (1) is changed to the amorphous polyester resin (6).

### Preparation of Amorphous Polyester Resin Dispersion (7) (PES7)

An amorphous polyester resin (7) is obtained in the same manner as in the preparation of the amorphous polyester resin (1), except that charging of the materials is changed as follows.
Terephthalic acid: 68 parts by mole
Isophthalic acid: 20 parts by mole
Adipic acid: 12 parts by mole
Ethylene glycol: 40 parts by mole
Propylene glycol: 40 parts by mole
Neopentyl glycol: 20 parts by mole

An ester group concentration of the obtained amorphous polyester resin (7) is 43.0% by mass.

An amorphous polyester resin dispersion (7) having a solid content of 20% by mass is obtained in the same manner as in the preparation of the amorphous polyester resin dispersion (1), except that the amorphous polyester resin (1) is changed to the amorphous polyester resin (7).

### Preparation of Amorphous Polyester Resin Dispersion (X)

Terephthalic acid: 80 parts by mole.

Dodecenyl succinic acid: 20 parts by mole
Propylene glycol: 10 parts by mole
Propylene oxide (2 mol) adduct of bisphenol A: 80 parts by mole
Ethylene oxide (2 mol) adduct of bisphenol A: 10 parts by mole

The above-described materials are charged into a reaction vessel equipped with a stirrer, a nitrogen introduction tube, a temperature sensor, and a rectifying column, the temperature is raised to 190° C. over 1 hour, and dibutyltin oxide is added to the mixture in an amount of 1.2 parts with respect to 100 parts of the above-described materials. While the generated water is distilled off, the temperature is raised to 240° C. for 6 hours, a dehydration condensation reaction is continued for 3 hours in the reaction solution retained at 240° C., and then the reactant is cooled to obtain an amorphous polyester resin (X).

An ester group concentration of the amorphous polyester resin (X) is 18.7% by mass.

An amorphous polyester resin dispersion (X) having a solid content of 20% by mass is obtained in the same manner as in the preparation of the amorphous polyester resin dispersion (1), except that the amorphous polyester resin (1) is changed to the amorphous polyester resin (X).

### Preparation of Styrene-(Meth)Acrylate Copolymer Particle Dispersion (B2)

### Emulsion (2)

Styrene: 40 parts
n-Butyl acrylate: 21.5 parts
Ethyl acrylate: 37 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (2).

A styrene-(meth)acrylate copolymer particle dispersion (2) having a concentration of solid contents of 20% by mass is obtained in the same manner as in the preparation of the styrene-(meth)acrylate copolymer particle dispersion (1), except that the emulsion (1) is changed to the emulsion (2).

An ester group concentration of the obtained resin particles is 20.0% by mass.

### Preparation of Styrene-(Meth)Acrylate Copolymer Particle Dispersion (B3)

### Emulsion (3)

Styrene: 50 parts
n-Butyl acrylate: 36 parts
2-Ethylhexyl acrylate: 12.5 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (3).

A styrene-(meth)acrylate copolymer particle dispersion (3) having a concentration of solid contents of 20% by mass is obtained in the same manner as in the preparation of the styrene-(meth)acrylate copolymer particle dispersion (1), except that the emulsion (1) is changed to the emulsion (3).

An ester group concentration of the obtained resin particles is 13.0% by mass.

### Preparation of Styrene-(Meth)Acrylate Copolymer Particle Dispersion (B4)

### Emulsion (4)

Styrene: 40.6 parts
n-Butyl acrylate: 58.5 parts
Divinylbenzene: 0.9 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (4).

A styrene-(meth)acrylate copolymer particle dispersion (4) having a concentration of solid contents of 20% by mass is obtained in the same manner as in the preparation of the styrene-(meth)acrylate copolymer particle dispersion (1), except that the emulsion (1) is changed to the emulsion (4).

An ester group concentration of the obtained resin particles is 17.0% by mass.

### Preparation of Styrene-(Meth)Acrylate Copolymer Particle Dispersion (B5)

A styrene-(meth)acrylate copolymer particle dispersion (5) having a concentration of solid contents of 20% by mass is obtained in the same manner as in the preparation of the styrene-(meth)acrylate copolymer particle dispersion (1), except that the amount of the anionic surfactant (ELEMINOL MON-2) added to the reaction vessel is changed from 0.4 parts to 1.2 parts.

An ester group concentration of the obtained resin particles is 17.0% by mass.

### Preparation of Styrene-(Meth)Acrylate Copolymer Particle Dispersion (B6)

A styrene-(meth)acrylate copolymer particle dispersion (6) having a concentration of solid contents of 20% by mass is obtained in the same manner as in the preparation of the styrene-(meth)acrylate copolymer particle dispersion (1), except that the amount of the anionic surfactant (ELEMINOL MON-2) added to the reaction vessel is changed from 0.4 parts to 0.1 parts.

An ester group concentration of the obtained resin particles is 17.0% by mass.

### Preparation of Styrene-(Meth)Acrylate Copolymer Particle Dispersion (B7)

### Emulsion (7)

Styrene: 45 parts
n-Butyl acrylate: 10 parts
2-Ethylhexyl acrylate: 43.5 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (7).

A styrene-(meth)acrylate copolymer particle dispersion (7) having a concentration of solid contents of 20% by mass is obtained in the same manner as in the preparation of the styrene-(meth)acrylate copolymer particle dispersion (1), except that the emulsion (1) is changed to the emulsion (7).

An ester group concentration of the obtained resin particles is 11.7% by mass.

### Preparation of Styrene-(Meth)Acrylate Copolymer Particle Dispersion (B8)

### Emulsion (8)

Styrene: 48.5 parts
n-Butyl acrylate: 39 parts
2-Ethylhexyl acrylate: 11 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (8).

A styrene-(meth)acrylate copolymer particle dispersion (8) having a concentration of solid contents of 20% by mass is obtained in the same manner as in the preparation of the styrene-(meth)acrylate copolymer particle dispersion (1), except that the emulsion (1) is changed to the emulsion (8).

An ester group concentration of the obtained resin particles is 13.6% by mass.

### Preparation of Styrene-(Meth)Acrylate Copolymer Particle Dispersion (B9)

### Emulsion (9)

Styrene: 40 parts
n-Butyl acrylate: 20.5 parts
Ethyl acrylate: 38 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (9).

A styrene-(meth)acrylate copolymer particle dispersion (9) having a concentration of solid contents of 20% by mass is obtained in the same manner as in the preparation of the styrene-(meth)acrylate copolymer particle dispersion (1), except that the emulsion (1) is changed to the emulsion (9).

An ester group concentration of the obtained resin particles is 20.1% by mass.

### Preparation of Styrene-(Meth)Acrylate Copolymer Particle Dispersion (B10)

### Emulsion (10)

Styrene: 37 parts
n-Butyl acrylate: 15 parts
Ethyl acrylate: 46.5 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (10).

A styrene-(meth)acrylate copolymer particle dispersion (10) having a concentration of solid contents of 20% by mass is obtained in the same manner as in the preparation of the styrene-(meth)acrylate copolymer particle dispersion (1), except that the emulsion (1) is changed to the emulsion (10).

An ester group concentration of the obtained resin particles is 21.7% by mass.

### Preparation of Styrene-(Meth)Acrylate Copolymer Particle Dispersion (B11)

### Emulsion (11)

Styrene: 41.5 parts
n-Butyl acrylate: 58.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (11).

A styrene-(meth)acrylate copolymer particle dispersion (11) having a concentration of solid contents of 20% by mass is obtained in the same manner as in the preparation of the styrene-(meth)acrylate copolymer particle dispersion (1), except that the emulsion (1) is changed to the emulsion (11).

An ester group concentration of the obtained resin particles is 17.0% by mass.

### Preparation of (Meth)Acrylate Resin Particle Dispersion (B12)

### Emulsion (12)

Dodecyl acrylate: 98.5 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (12).

A (meth)acrylate copolymer particle dispersion (12) having a concentration of solid contents of 20% by mass is obtained in the same manner as in the preparation of the styrene-(meth)acrylate copolymer particle dispersion (1), except that the emulsion (1) is changed to the emulsion (12).

An ester group concentration of the obtained resin particles is 15.3% by mass.

### Preparation of Styrene-(Meth)Acrylate Copolymer Particle Dispersion (B13)

### Emulsion (13)

Styrene: 61 parts
n-Butyl acrylate: 37.5 parts
Divinylbenzene: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (13).

A styrene-(meth)acrylate copolymer particle dispersion (13) having a concentration of solid contents of 20% by mass is obtained in the same manner as in the preparation of the styrene-(meth)acrylate copolymer particle dispersion (1), except that the emulsion (1) is changed to the emulsion (13).

An ester group concentration of the obtained resin particles is 10.9% by mass.

### Preparation of Release Agent Particle Dispersion (2)

A release agent particle dispersion (2) having a solid content of 20% by mass is obtained in the same manner as in the preparation of the release agent particle dispersion (1), except that the paraffin wax w1 is changed to an ester wax w2 (product name: WEP-3, manufactured by NOF Corporation, ester group concentration: 6.6% by mass, melting point: 72° C.).

### Preparation of Release Agent Particle Dispersion (3)

A release agent particle dispersion (3) having a solid content of 20% by mass is obtained in the same manner as in the preparation of the release agent particle dispersion (1), except that the paraffin wax w1 is changed to an ester wax w3 (product name: WEP-6, manufactured by NOF Corporation, ester group concentration: 14.4% by mass, melting point: 77° C.).

### Preparation of Release Agent Particle Dispersion (4)

A release agent particle dispersion (4) having a solid content of 20% by mass is obtained in the same manner as in the preparation of the release agent particle dispersion (1), except that the paraffin wax w1 is changed to a paraffin wax w4 (product name: SP-1039, manufactured by NIPPON SEIRO CO., LTD., ester group concentration: 0% by mass, melting point: 60° C.).

### Preparation of Release Agent Particle Dispersion (5)

A release agent particle dispersion (5) having a solid content of 20% by mass is obtained in the same manner as in the preparation of the release agent particle dispersion (1), except that the paraffin wax w1 is changed to a polyethylene w5 (product name: Hi-WAX 420P, manufactured by Mitsui Chemicals, Inc., ester group concentration: 0% by mass, melting point: 116° C.).

### Preparation of Release Agent Particle Dispersion (6)

A release agent particle dispersion (6) having a solid content of 20% by mass is obtained in the same manner as in the preparation of the release agent particle dispersion (1), except that the paraffin wax w1 is changed to a fatty acid amide wax w6 (product name: FATTY AMIDE S, manufactured by Kao Corporation, ester group concentration: 0% by mass, melting point: 100° C.).

### Preparation of Release Agent Particle Dispersion (7)

A release agent particle dispersion (7) having a solid content of 20% by mass is obtained in the same manner as in the preparation of the release agent particle dispersion (1), except that the paraffin wax w1 is changed to a polyethylene w7 (product name: POLYWAX 625, manufactured by Nucera Solutions, ester group concentration: 0% by mass, melting point: 99° C.).

### Method of Measuring Ester Group Concentration

The ester group concentration can be calculated from the number of ester groups [—C(═O)O—] in the resin or the compound, and specifically, is represented by the following expression.

$$Ester group concentration ( \% by mass ) = [ ( N \times 44 ) / number - average molecular weight ] \times 100$$

Here, N is the average number of ester groups per molecule, and 44 is a formula weight of the ester group [—C(═O)O—].

The chemical structure of the monomer formulation or the compound and the number of ester groups are determined and calculated by using a nuclear magnetic resonance spectrum (NMR) or the like.

Evaluation of Fixing Property and Density Unevenness Suppression Property in High Humidity Environment

In an environment of 25° C./80% RH, evaluation is performed using paper (GR100; manufactured by FUJIFILM Business Innovation Corporation) left to stand for 1 week after opening, with Apeos C7070 (manufactured by FUJIFILM Business Innovation Corporation).

Specifically, 100 sheets of solid images of 20 mm×20 mm are continuously printed, and the presence or absence of fixing failure is visually determined.
A: no fixing failure occurs in all of the 100 sheets.
B: minor fixing failure occurs in 3 or fewer sheets out of the 100 sheets.
C: fixing failure occurs on 4 sheets or more out of the 100 sheets.

In addition, regarding the image defect, 10,000 sheets of an image pattern in which a vertically strip-shaped solid image of A4 size is disposed in an environment of 25° C./80% RH are printed, and then the printed full halftone (30%) image is evaluated. In the full halftone (30%) image, a difference between an average value of 5 measurements of the image density at positions corresponding to the positions of the images of the strip-shaped image printed 10,000 sheets before the full halftone image and an average value of 5 measurements of the density at positions corresponding to the positions of the non-image areas of the strip-shaped image is evaluated. The image density is measured with X-Rite 404 (manufactured by X-Rite, Inc.).
A: density difference between the image area and the non-image area is less than 0.02, and a uniform image is obtained.
B: density difference between the image area and the non-image area is 0.02 or more and less than 0.05, and the unevenness is at a level at which the unevenness is hardly noticeable.
C: density difference between the image area and the non-image area is 0.05 or more and less than 0.10, that is an acceptable level.
D: density difference between the image area and the non-image area is 0.10 or more, that is an unacceptable level.

TABLE 1

| | | Binder resin (matrix) | | | | | | | | | |
|---|---|---|---|---|---|---|---|---|---|---|---|
| | | | | | | | | Average | Resin particles (domain) | | |
| | | Resin 1 | | | Resin 2 | | | ester | | Ester group | THF- |
| | | | Ester group | Addition | | Ester group | Addition | group | | concen- | insoluble |
| | | | concen- | amount | | concen- | amount | concen- | | tration | amount |
| | | | tration | (% by | | tration | (% by | tration c1 | | c2 | (% by |
| | Toner | Type | (% by mass) | mass) | Type | (% by mass) | mass) | (% by mass) | Type | (% by mass) | mass) |
| Example 1 | 1 | PES1 | 38.9 | 78 | — | — | — | 38.9 | B1 | 17.0 | 95 |
| Example 2 | 2 | PES2 | 48.0 | 78 | — | — | — | 48.0 | B2 | 20.0 | 92 |
| Example 3 | 3 | PES3 | 45.0 | 78 | — | — | — | 45.0 | B2 | 20.0 | 92 |
| Example 4 | 4 | PES4 | 30.0 | 78 | — | — | — | 30.0 | B3 | 13.0 | 96 |
| Example 5 | 5 | PES5 | 25.0 | 78 | — | — | — | 25.0 | B3 | 13.0 | 96 |
| Example 6 | 6 | PES1 | 38.9 | 78 | — | — | — | 38.9 | B4 | 17.0 | 80 |
| Example 7 | 7 | PES1 | 38.9 | 78 | — | — | — | 38.9 | B5 | 17.0 | 98 |
| Example 8 | 8 | PES1 | 38.9 | 78 | — | — | — | 38.9 | B6 | 17.0 | 94 |
| Example 9 | 9 | PES1 | 38.9 | 78 | — | — | — | 38.9 | B1 | 17.0 | 95 |
| Example 10 | 10 | PES1 | 38.9 | 78 | — | — | — | 38.9 | B1 | 17.0 | 95 |
| Example 11 | 11 | PES1 | 38.9 | 78 | — | — | — | 38.9 | B1 | 17.0 | 95 |
| Example 12 | 12 | PES1 | 38.9 | 78 | — | — | — | 38.9 | B1 | 17.0 | 95 |
| Example 13 | 13 | PES1 | 38.9 | 78 | — | — | — | 38.9 | B7 | 11.7 | 90 |
| Example 14 | 14 | PES1 | 38.9 | 78 | — | — | — | 38.9 | B8 | 13.6 | 87 |
| Example 15 | 15 | PES6 | 31.0 | 78 | — | — | — | 31.0 | B9 | 20.1 | 97 |
| Example 16 | 16 | PES6 | 31.0 | 78 | — | — | — | 31.0 | B10 | 21.7 | 97 |
| Example 17 | 17 | PES1 | 38.9 | 39 | PES4 | 30.0 | 39 | 34.5 | B1 | 17.0 | 95 |
| Example 18 | 18 | PES1 | 38.9 | 80 | — | — | — | 38.9 | B1 | 17.0 | 95 |
| Example 19 | 19 | PES1 | 38.9 | 81 | — | — | — | 38.9 | B1 | 17.0 | 95 |
| Example 20 | 20 | PES1 | 38.9 | 73 | — | — | — | 38.9 | B1 | 17.0 | 95 |
| Example 21 | 21 | PES1 | 38.9 | 69 | — | — | — | 38.9 | B1 | 17.0 | 95 |
| Example 22 | 22 | PES1 | 38.9 | 88.5 | — | — | — | 38.9 | B1 | 17.0 | 95 |
| Example 23 | 23 | PES1 | 38.9 | 78 | — | — | — | 38.9 | B11 | 17.0 | 0 |
| Example 24 | 24 | PES1 | 38.9 | 78 | — | — | — | 38.9 | B12 | 15.3 | 90 |
| Example 25 | 25 | PES1 | 38.9 | 78 | — | — | — | 38.9 | B1 | 17.0 | 95 |
| Example 26 | 26 | PES7 | 43.0 | 78 | — | — | — | 43.0 | B1 | 17.0 | 95 |
| Example 27 | 1 | PES1 | 38.9 | 78 | — | — | — | 38.9 | B1 | 17.0 | 95 |
| Comparative | cl | X | 18.7 | 78 | — | — | — | 18.7 | B1 | 17.0 | 95 |
| Example 1 | | | | | — | — | — | | | | |
| Comparative | c2 | PES1 | 38.9 | 78 | — | — | — | 38.9 | B13 | 11.0 | 94 |
| Example 2 | | | | | — | — | — | | | | |

| | Resin particles (domain) | | | | | | | | | |
|---|---|---|---|---|---|---|---|---|---|---|
| | Average | | Release agent | | | | Ratio of | | | |
| | equivalent | Addition | | Ester group | | Addition | ester | | Evaluation | |
| | circle | amount | | concen- | | amount | group | | Density | |
| | diameter | Wb | | tration | Melting | Ww | concen- | | unevenness | |
| | of domain | (% by | | c3 | point | (% by | tration | | suppression | Fixing |
| | (nm) | mass) | Type | (% by mass) | (° C.) | mass) | c2/cl | Wb/Ww | property | property |
| Example 1 | 150 | 8 | w1 | 0.0 | 75 | 7 | 0.44 | 1.1 | A | A |
| Example 2 | 180 | 8 | w1 | 0.0 | 75 | 7 | 0.42 | 1.1 | C | A |
| Example 3 | 180 | 8 | w1 | 0.0 | 75 | 7 | 0.44 | 1.1 | A | A |
| Example 4 | 160 | 8 | w1 | 0.0 | 75 | 7 | 0.43 | 1.1 | A | A |
| Example 5 | 160 | 8 | w1 | 0.0 | 75 | 7 | 0.52 | 1.1 | B | B |
| Example 6 | 120 | 8 | w1 | 0.0 | 75 | 7 | 0.44 | 1.1 | B | A |
| Example 7 | 50 | 8 | w1 | 0.0 | 75 | 7 | 0.44 | 1.1 | B | A |
| Example 8 | 300 | 8 | w1 | 0.0 | 75 | 7 | 0.44 | 1.1 | B | A |
| Example 9 | 150 | 8 | w2 | 5.0 | 80 | 7 | 0.44 | 1.1 | A | A |
| Example 10 | 150 | 8 | w3 | 15.0 | 70 | 7 | 0.44 | 1.1 | B | A |
| Example 11 | 150 | 8 | w4 | 0.0 | 60 | 7 | 0.44 | 1.1 | B | A |
| Example 12 | 150 | 8 | w5 | 0.0 | 120 | 7 | 0.44 | 1.1 | B | A |
| Example 13 | 200 | 8 | w1 | 0.0 | 75 | 7 | 0.30 | 1.1 | C | A |
| Example 14 | 190 | 8 | w1 | 0.0 | 75 | 7 | 0.35 | 1.1 | A | A |
| Example 15 | 140 | 8 | w1 | 0.0 | 75 | 7 | 0.65 | 1.1 | A | A |
| Example 16 | 140 | 8 | w1 | 0.0 | 75 | 7 | 0.70 | 1.1 | C | A |
| Example 17 | 150 | 8 | w1 | 0.0 | 75 | 7 | 0.49 | 1.1 | A | A |
| Example 18 | 150 | 3 | w1 | 0.0 | 75 | 10 | 0.44 | 0.3 | B | A |
| Example 19 | 150 | 4 | w1 | 0.0 | 75 | 8 | 0.44 | 0.5 | A | A |
| Example 20 | 150 | 16 | w1 | 0.0 | 75 | 4 | 0.44 | 4.0 | A | A |
| Example 21 | 150 | 20 | w1 | 0.0 | 75 | 4 | 0.44 | 5.0 | B | A |
| Example 22 | 150 | 3.5 | w1 | 0.0 | 75 | 1 | 0.44 | 3.5 | B | A |
| Example 23 | 500 | 8 | w1 | 0.0 | 75 | 7 | 0.44 | 1.1 | C | A |
| Example 24 | 150 | 8 | w1 | 0.0 | 75 | 7 | 0.39 | 1.1 | C | A |
| Example 25 | 150 | 8 | w6 | 0.0 | 70 | 7 | 0.44 | 1.1 | C | A |
| Example 26 | 150 | 8 | w1 | 0.0 | 75 | 7 | 0.40 | 1.1 | A | A |
| Example 27 | 150 | 8 | w7 | 0.0 | 99 | 7 | 0.44 | 1.1 | A | A |
| Comparative | 150 | 8 | w1 | 0.0 | 75 | 7 | 0.91 | 1.1 | C | C |
| Example 1 | | | | | | | | | | |
| Comparative | 170 | 8 | w1 | 0.0 | 75 | 7 | 0.28 | 1.1 | D | A |
| Example 2 | | | | | | | | | | |

As shown in Table 1, the electrostatic charge image developing toners of Examples are excellent in the density unevenness suppression property in a high humidity environment, as compared with the electrostatic charge image developing toners of Comparative Examples.

(((1))) An electrostatic charge image developing toner comprising:
toner particles that contain a binder resin, a release agent, and resin particles forming a domain inside the toner particles,
wherein the binder resin includes a polyester resin,
an average ester group concentration c1 of the binder resin is 25% by mass or more and 48% by mass or less, and
in a case where an ester group concentration of the resin particles is denoted by c2, a value of c2/c1 is 0.30 or more and 0.70 or less.

(((2))) The electrostatic charge image developing toner according to (((1))),
wherein a content of the release agent is 1% by mass or more and 10% by mass or less with respect to a total mass of the toner particles.

(((3))) The electrostatic charge image developing toner according to (((1))) or (((2))),
wherein, in the toner particles, in a case where a content of the release agent is denoted by Ww and a content of the resin particles is denoted by Wb, a value of Wb/Ww is 0.3 or more and 5.0 or less.

(((4))) The electrostatic charge image developing toner according to any one of (((1))) to (((3))),
wherein an average equivalent circle diameter of the domain formed by the resin particles is 50 nm or more and 300 nm or less.

(((5))) The electrostatic charge image developing toner according to any one of (((1))) to (((4))),
wherein a melting point of the release agent is 60° C. or higher and 120° C. or lower.

(((6))) The electrostatic charge image developing toner according to any one of (((1))) to (((5))),
wherein the resin particles are styrene (meth)acrylic resin particles.

(((7))) The electrostatic charge image developing toner according to any one of (((1))) to (((6))),
wherein the resin particles are crosslinked resin particles.

(((8))) The electrostatic charge image developing toner according to any one of (((1))) to (((7))),
wherein a tetrahydrofuran-insoluble amount of the resin particles is 80% by mass or more.

(((9))) The electrostatic charge image developing toner according to any one of (((1))) to (((8))),
wherein the release agent includes at least one selected from the group consisting of a hydrocarbon wax and an ester wax.

(((10))) The electrostatic charge image developing toner according to any one of (((1))) to (((9))),
wherein an ester group concentration c3 of the release agent is 15% by mass or less.

(((11))) An electrostatic charge image developer comprising:
the electrostatic charge image developing toner according to any one of (((1))) to (((10))).

(((12))) A toner cartridge comprising:
a container that contains the electrostatic charge image developing toner according to any one of (((1))) to (((10))),
wherein the toner cartridge is detachable from an image forming apparatus.

(((13))) A process cartridge comprising:
a developing device that contains the electrostatic charge image developer according to (((11))) and develops an electrostatic charge image formed on a surface of an image holder as a toner image using the electrostatic charge image developer,
wherein the process cartridge is detachable from an image forming apparatus.

(((14))) An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((11))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

(((15))) An image forming method comprising:
charging a surface of an image holder;
forming an electrostatic charge image on the charged surface of the image holder;
developing the electrostatic charge image formed on the surface of the image holder as a toner image using the electrostatic charge image developer according to (((11)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles that contain a binder resin, a release agent, and resin particles forming a domain inside the toner particles,
wherein the binder resin includes a polyester resin,
an average ester group concentration c1 of the binder resin is 25% by mass or more and 48% by mass or less, and
in a case where an ester group concentration of the resin particles is denoted by c2, a value of c2/c1 is 0.30 or more and 0.70 or less.

2. The electrostatic charge image developing toner according to claim 1,
wherein a content of the release agent is 1% by mass or more and 10% by mass or less with respect to a total mass of the toner particles.

3. The electrostatic charge image developing toner according to claim 1,
wherein, in the toner particles, in a case where a content of the release agent is denoted by Ww and a content of the resin particles is denoted by Wb, a value of Wb/Ww is 0.3 or more and 5.0 or less.

4. The electrostatic charge image developing toner according to claim 1,
wherein an average equivalent circle diameter of the domain formed by the resin particles is 50 nm or more and 300 nm or less.

5. The electrostatic charge image developing toner according to claim 1,
wherein a melting point of the release agent is 60° C. or higher and 120° C. or lower.

6. The electrostatic charge image developing toner according to claim 1,
wherein the resin particles are styrene (meth)acrylic resin particles.

7. The electrostatic charge image developing toner according to claim 1,
wherein the resin particles are crosslinked resin particles.

8. The electrostatic charge image developing toner according to claim 1,
wherein a tetrahydrofuran-insoluble amount of the resin particles is 80% by mass or more.

9. The electrostatic charge image developing toner according to claim 1,
wherein the release agent includes at least one selected from the group consisting of a hydrocarbon wax and an ester wax.

10. The electrostatic charge image developing toner according to claim 1,
wherein an ester group concentration c3 of the release agent is 15% by mass or less.

11. An electrostatic charge image developer comprising:
the electrostatic charge image developing toner according to claim 1.

12. An electrostatic charge image developer comprising:
the electrostatic charge image developing toner according to claim 2.

13. An electrostatic charge image developer comprising:
the electrostatic charge image developing toner according to claim 3.

14. An electrostatic charge image developer comprising:
the electrostatic charge image developing toner according to claim 4.

15. An electrostatic charge image developer comprising:
the electrostatic charge image developing toner according to claim 5.

16. An electrostatic charge image developer comprising:
the electrostatic charge image developing toner according to claim 6.

17. A toner cartridge comprising:
a container that contains the electrostatic charge image developing toner according to claim 1,
wherein the toner cartridge is detachable from an image forming apparatus.

18. A process cartridge comprising:
a developing device that contains the electrostatic charge image developer according to claim 11 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 11 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 11;
transferring the toner image formed on the surface of the image holder to a surface of a recording medium; and
fixing the toner image transferred to the surface of the recording medium.
